(19) United States
(12) Patent Application Publication
(10) Pub. No.: US 2020/0230714 A1
(43) Pub. Date: Jul. 23, 2020

(54) CUTTING END MILL

(71) Applicant: HALCYON GROUP, Bangkok (TH)

(72) Inventor: Pete RIMCHALA, Bangkok (TH)

(21) Appl. No.: 16/744,168

(22) Filed: Jan. 15, 2020

(30) Foreign Application Priority Data
Jan. 18, 2019 (TH) 1903000129

(51) Int. Cl. B23B 51/02; B23C 5/10

(52) U.S. Cl. CPC B23B 51/02; B23C 5/10; B23C 2226/315; B23B 2251/043; B23B 2251/241; B23C 2210/04; B23B 2251/40

(57) ABSTRACT

An object of the present invention is to provide helically fluted end mill with a diamond cutting surface. More particularly, it is an object of the present invention to provide a helically fluted end mill with helical grooves in the flutes that are filled with compacted polycrystalline diamond that can provide an effective cutting length based on the appropriate relationship between cutting length, diameter, the number of flutes, angle, and the number of polycrystalline diamond segments per flute.

### CROSS-REFERENCE TO RELATED APPLICATIONS

The present application claims priority to Thailand Petty Patent Application No. 1903000129, filed on Jan. 18, 2019, the contents of which are incorporated herein by reference.

### FIELD OF THE INVENTION

This invention relates to rotary cutting tools and more particularly to cutting end mills.

### BACKGROUND OF THE INVENTION

Fluted end mills are commonly used milling tools and are generally required to perform severe machining operations under extremely adverse conditions. In the prior arts, the cutting surfaces of one material are formed on the body and shaft. There are many possible combinations including diamond inserts or tips on carbon steel or carbide shafts. In such combination, a diamond tip or insert must first be adhered to a carbide substrate which is in turn soldered or brazed to the shaft. Diamond particles being polycrystalline superabrasive materials are typically formed into a compact or PCD (polycrystalline diamond) disc. Though, PCD and PCBN have been used in both metalworking and woodworking industries due to their high abrasive resistance, high toughness, and high hardness, these superabrasive materials have not been effective in other cutting tool industry especially in milling and drilling applications due primarily to availability and cost factors.

The main drawback is related to the unique design or shape of tool products in which the cutting face of PCD or PCBN is fluted or helical shaped for an effective cutting performance. Generally, helical shapes are not readily fabricated from PCD or PCBN under High Pressure High Temperature (HPHT) sintering process due to complexity in designs in combination with their superhard physical characteristics. Furthermore, any conventional shaping process in an attempt to put the flute or helical shape into a superabrasive material by finishing operations such as grinding is a difficult and costly process. This is also applicable in the case that superabrasive parts having a nearly net shape of a desirable final product design. Therefore, although some progress has been made in the past few years, the market in the field of the cutting tool industry has a need for the helical or fluted PCD drill tip and a reliable PCD fluted end mill that are cost competitive and reliable in tool performance over the existing superabrasive tools.

### SUMMARY OF THE INVENTION

An object of the present invention is to provide helically fluted end mill with a diamond cutting surface. More particularly, it is an object of the present invention to provide a helically fluted end mill with helical grooves in the flutes that are filled with compacted polycrystalline diamond that can provide an effective cutting length based on the appropriate relationship between the diameter, number of flutes, angle, and the number of polycrystalline diamond segments per flute.

A cutting end mill as disclosed comprises a cutting end and a base end and a body having a cylindrical sidewall therebetween and a longitudinal central axis; a groove across the cutting end; at least one flute on the sidewall penetrating the body and extending from the cutting end toward base end; a groove adjacent to an edge of each flute spirally extending along the sidewall; polycrystalline materials affixed onto the groove characterized in that polycrystalline materials are formed into a plurality of segments having different angles and lengths per flute is in the number of 2 to 30 and wherein a spiral angle is in the range of 5 to 60 degree thereby providing the maximum cutting length of 128 mm.

In one aspect, a plurality of polycrystalline diamond segments can be mounted on flutes and can be arranged in a two-dimensional array configuration wherein each segment is positioned along a flute in a continuous manner thereby forming a horizontal array and each segment on one flute is substantially aligned to other corresponding segment in any adjacent flutes thereby forming a vertical array. This embodiment can avoid the limitation found from the prior works in which a single piece of flat (two-dimensional) PCD segment cannot be brazed onto the carbide shank due to the flute's twisted and helical geometry. With this embodiment, there are multiple pieces of segment along one flute. However, from the research findings, the segment edge(s) that will be placed adjacent to another segment in order to form a cutting edge must be arranged in the manner that the segment edge of one flute does not exactly align with those of other adjacent flutes in the vertical array. Each segment on one flute should rather be substantially aligned to other corresponding segment in any adjacent flutes with a displacement of the alignment in the range of 0.3-1.0 mm. In such embodiment, a displacement of the alignment is preferably in the range of 0.5-1.0 mm.

Additionally, for the possible embodiment as mentioned above, the width of a segment should be configured in the range of 1.5-5 mm and the length should be configured in the range of 3.2-18 mm. However, the preferable width of a segment is in the range of 2-3 mm.

In the other aspect, A cutting end mill according to this invention has a positive rake angles up to 12 degrees radial and the preferable/optimal range is between 5 to 7 degrees.

The products of the present invention are economically and technically viable product when compared to existing PCD related tools being commercialized currently even in limited amounts. The ability to manufacture products according to this invention with the cost control is possible due to the relationship between the cutting length, diameter number of flutes, angle, and the number of polycrystalline diamond segments per flute found from the experiments.

The objectives and unique characteristics and other aspects of this invention will be described in more detail by way of the examples and drawings included and the best mode will also be further described.

### BRIEF DESCRIPTION OF THE DRAWINGS

FIG. 1 shows the side view of the preferred embodiment.

FIG. 2 shows the front view of the preferred embodiment.

FIG. 3 shows the table demonstrating the possible lengths and the associated parameters.

### DETAILED DESCRIPTION OF PREFERRED EMBODIMENTS

For a better understanding of the preferred embodiment and to show how it may be performed, it will now be described in more detail by way of examples only with reference to the accompanying drawings. The parts shown in the drawings will be represented by the referenced number. The description, however, does not imply to any limitation, and the scope of the invention will be in accordance with the claims attached herein.

A cutting end mill as disclosed comprises a cutting end and a base end and a body having a cylindrical sidewall therebetween and a longitudinal central axis; a groove across the cutting end; at least one tlute on the sidewall penetrating the body and extending from the cutting end toward base end; a groove adjacent to an edge of each flute spirally extending along the sidewall; polycrystalline materials affixed onto the groove characterized in that polycrystalline materials are formed into a plurality of segments having different angles and lengths per flute is in the number of 2 to 30 and wherein a spiral angle is in the range of 5 to 60 degree thereby providing the maximum cutting length of 128 mm.

In one aspect, a plurality of polycrystalline diamond segments can be mounted on flutes and can be arranged in a two-dimensional array configuration wherein each segment is positioned along a flute in a continuous manner thereby forming a horizontal array and each segment on one flute is substantially aligned to other corresponding segment in any adjacent flutes thereby forming a vertical array. This embodiment can avoid the limitation found from the prior works in which a single piece of flat (two-dimensional) PCD segment cannot be brazed onto the carbide shank due to the flute's twisted and helical geometry. With this embodiment, there are multiple pieces of segment along one flute. However, from the research findings, the segment edge(s) that will be placed adjacent to another segment in order to form a cutting edge must be arranged in the manner that the segment edge of one flute does not exactly align with those of other adjacent flutes in the vertical array. Each segment on one flute should rather be substantially aligned to other corresponding segment in any adjacent flutes with a displacement of the alignment in the range of 0.3-1.0 mm. In such embodiment, a displacement of the alignment is preferably in the range of 0.5-1.0 mm.

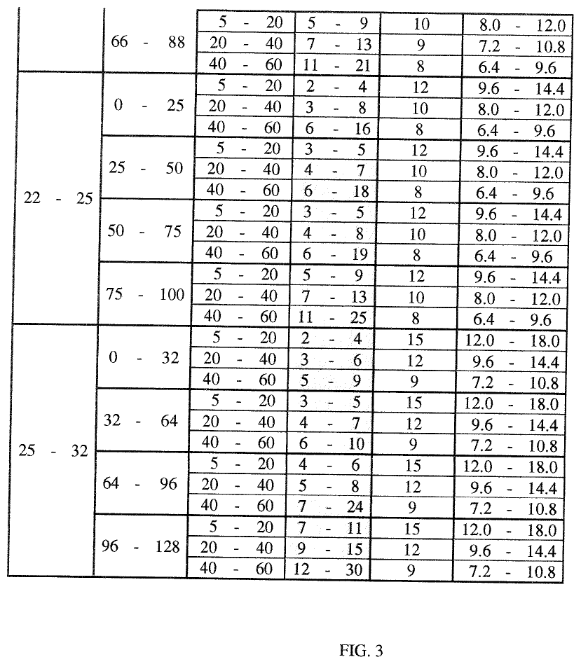

Additionally, for the possible embodiment as mentioned above, the width of a segment should be configured in the range of 1.5-5 mm. and the length should be configured in the range of 3.2-18 mm. However, the preferable width of a segment is in the range of 2-3 mm. For the segment length, different preferable lengths can be used primarily depending on the cutting diameter, cutting length, and helix angle. For certain embodiments, the length can be in the range of 3.2-10.8 when the cutting diameter is in the range of 8-10, the cutting length is in the range of 0-40, and the helix angle is in the range of 5-60 degrees. The length can also be in the range of 4-10.8 when the cutting diameter is in the range of 10-16, the cutting length is in the range of 0-64, and the helix angle is in the range of 5-60 degrees. The length can also be in the range of 4.8-10.8 when the cutting diameter is in the range of 16-18, the cutting length is in the range of 0-72, and the helix angle is in the range of 5-60 degrees. The length can also be in the range of 6.4-12 when the cutting diameter is in the range of 18-22, the cutting length is in the range of 0-88, and the helix angle is in the range of 5-60 degrees. The length can also be in the range of 6.4-14.4 when the cutting diameter is in the range of 22-25, the cutting length is in the range of 0-100, and the helix angle is in the range of 5-60 degrees. The length can also be in the range of 7.2-18 when the cutting diameter is in the range of 25-32, the cutting length is in the range of 0-128, and the helix angle is in the range of 5-60 degrees. The findings from the experiments are incorporated as per the table shown in FIG. 3.

Additionally, for the preferred embodiments, a cutting end mill in any of the above claims wherein the maximum number of flutes is 12. Polycrystalline materials according to these embodiments can be PCD or PCBN brazed or soldered onto the groove.

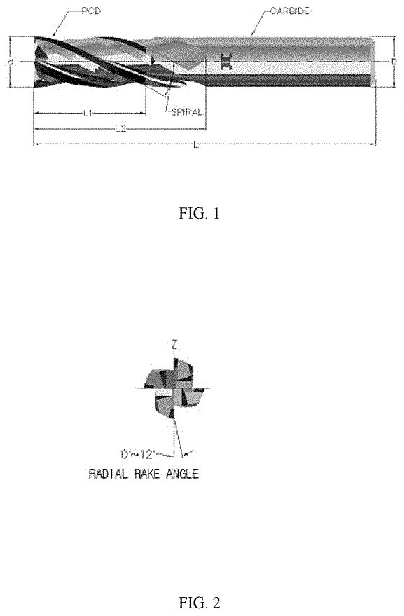

The finished product according to one of the embodiments is shown in FIG. 1, the preferred embodiment has a body in the shape of a round shaft. However, other shapes could be used to form the body of the tool, including, but not limited to, rectangular or other angular shapes. The body of the tool can have varying widths, depending on the size of the intended tool holder, or preferences of the user. Further, an end of the tool can be shaped or formed to fit with several tool holders, depending on the user's preferences. FIG. 1 shows the end as a round, flat end. However, other end shapes could include, but are not limited to, square, oval, spindle, or other angular shapes. In one embodiment, the body is made of tungsten carbide. In another embodiment, the body is made of metal.

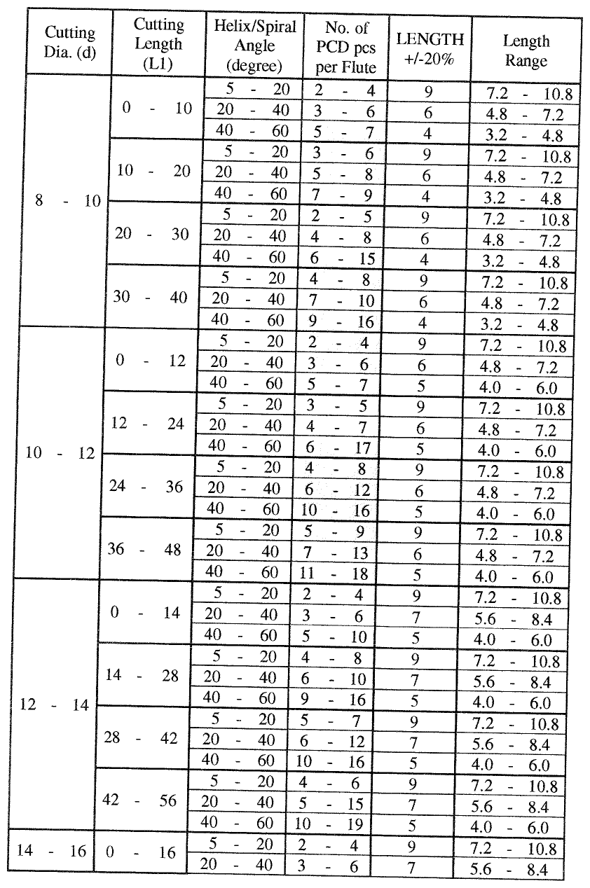

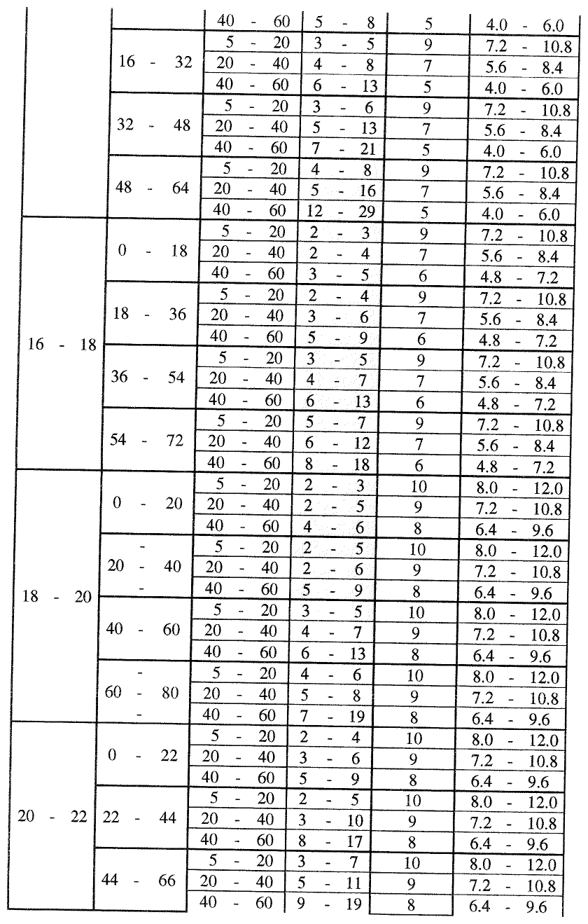

One aspect that distinguishes the end mills according to this invention and those currently available in the market is the radial rake angle. PCD pieces for normal PCD end mill are unmachined, therefore are flat (2-dimensional). PCD pieces for this present invention are machined to create a 3-dimensional geometry thereby providing the desired radial rake angle and spiral angle. FIG. 2 shows a tip of the tool according to one of the possible embodiments which is made of four flutes. A positive rake angles up to 12 degrees radial is used in this embodiment wherein the preferable/optimal range is between 5 to 7 degrees. Such range may be varied depending on the application, material being cut, surface finish requirements, diameter and cutting length and other relevant machining parameters. Hence, the product according to this embodiment can cut materials with less force from its shearing effect thereby reducing heat occurred.

Several advantages can thus be appreciated from the invention as per this disclosure. These include the smaller gap between segments and the longer tool life when compared to carbide end mill. This present invention can also have hook or scoop on the rake face, which then leads to a better result with regard to the surface finish. Hence, there is lower cutting force. Under the characteristics of the relevant parameters found from the research, the effective cutting area can be maintained or enhanced and the flexibility in terms of the manufacturing process and usability is clearly improve while the cost of the components can be controlled.

It will be appreciated by persons skilled in the art that the present inventions are not limited by what has been particularly shown described hereinabove. Rather the scope of the present invention includes both combinations and sub-combinations of the features described hereinabove as well as modifications and variations thereof which would occur to a person of skill in the art upon reading the foregoing description and which are not in the prior art.

### Best Mode

As disclosed in the details of the preferred embodiments as aforementioned.

1. A cutting end mill comprising
A cutting end and a base end and a body having a cylindrical sidewall therebetween and a longitudinal central axis;
A groove across the cutting end;
At least one flute on the sidewall penetrating the body and extending from the cutting end toward base end;
A groove adjacent to an edge of each flute spirally extending along the sidewall;
polycrystalline materials affixed onto the groove
characterized in that polycrystalline materials are formed into a plurality of segments having different angles and lengths per flute is in the number of 2 to 30 and wherein a spiral angle is in the range of 5 to 60 degree thereby providing the maximum cutting length of 128 mm.

2. A cutting end mill according to claim 1 wherein a plurality of polycrystalline diamond segments mounted on flutes are arranged in a two-dimensional array configuration wherein each segment is positioned along a flute in a continuous manner thereby forming a horizontal array and each segment on one flute is substantially aligned to other corresponding segment in any adjacent flutes with a displacement of the alignment in the range of 0.3-1.0 mm. thereby forming a vertical array.

3. A cutting end mill according to claim 2 wherein a displacement of the alignment is preferably in the range of 0.5-1.0 mm.

4. A cutting end mill according to claim 1, wherein the width of a segment is in the range of 1.5-5 mm. and the length is in the range of 3.2-18 mm.

5. A cutting end mill according to claim 4 wherein the width of a segment is in the range of 2-3 mm.

6. A cutting end mill according to claim 4 wherein the length is in the range of 3.2-10.8 when the cutting diameter is in the range of 8-10, the cutting length is in the range of 0-40, and the helix angle is in the range of 5-60 degrees.

7. A cutting end mill according to claim 4 wherein the length is in the range of 4-10.8 when the cutting diameter is in the range of 10-16, the cutting length is in the range of 0-64, and the helix angle is in the range of 5-60 degrees.

8. A cutting end mill according to claim 4 wherein the length is in the range of 4.8-10.8 when the cutting diameter is in the range of 16-18, the cutting length is in the range of 0-72, and the helix angle is in the range of 5-60 degrees.

9. A cutting end mill according to claim 4 wherein the length is in the range of 6.4-12 when the cutting diameter is in the range of 18-22, the cutting length is in the range of 0-88, and the helix angle is in the range of 5-60 degrees. A cutting end mill according to claim 4 wherein the length is in the range of 6.4-14.4 when the cutting diameter is in the range of 22-25, the cutting length is in the range of 0-100, and the helix angle is in the range of 5-60 degrees.

10. A cutting end mill according to claim 4 wherein the length is in the range of 7.2-18 when the cutting diameter is in the range of 25-32, the cutting length is in the range of 0-128, and the helix angle is in the range of 5-60 degrees.

11. A cutting end mill according to claim 1, wherein the said tool has a rake angle up to 12 degrees and preferably in the range between 5-7 degrees.

12. A cutting end mill according to claim 1, wherein the maximum number of flutes is 12.

13. A cutting end mill according to claim 1, wherein polycrystalline materials are PCD or PCBN brazed or soldered onto the groove.
